(19) United States
(12) Patent Application Publication
(10) Pub. No.: US 2022/0299594 A1
(43) Pub. Date: Sep. 22, 2022

(54) MILLIMETER WAVE RADAR ON FLEXIBLE PRINTED CIRCUIT BOARD

(71) Applicant: Google LLC, Mountain View, CA (US)

(72) Inventors: Daran Wang, Los Altos, CA (US); Changzhan Gu, San Jose, CA (US); Michael Diamond, Mountain View, CA (US); Zhen Pan, Milpitas, CA (US)

(21) Appl. No.: 17/753,213

(22) PCT Filed: Oct. 14, 2020
(86) PCT No.: PCT/US2020/055579

§ 371 Date: Feb. 23, 2022

Related U.S. Application Data
(60) Provisional application No. 62/914,976, filed on Oct. 14, 2019.

(51) Int. Cl. G01S 7/02; G01J 1/42; H04R 3/12; H01Q 1/48; H01Q 1/52; H01Q 1/38

(52) U.S. Cl. CPC G01S 7/023; G01J 1/4204; H04R 3/12; H01Q 1/48; H01Q 1/526; H01Q 1/38

(57) ABSTRACT

An example computing device includes a printed circuit board comprising: a first layer including one or more ground signal paths; a second layer including one or more ground signal paths; a third layer disposed between the first layer and the second layer; a radar antenna portion comprising a first radar antenna and electrically connected to a distal connector of the printed circuit board; a radar clock signal line configured to convey a radar clock signal between the radar antenna portion and the distal connector; and a first ground guard trace electrically coupled to the one or more ground signal paths and positioned adjacent to a first side of the radar clock signal line and parallel to a length of the radar clock signal line.

This application claims the benefit of U.S. Provisional Application Ser. No. 62/914,976, filed Oct. 14, 2019, the entire contents of which are hereby incorporated by reference.

### BACKGROUND

Mobile devices may employ a variety of technologies to receive input from a user. For example, a user may provide input to a mobile device by depressing one or more buttons and by entering text using the keys of a keypad. A mobile device may include a microphone to detect and respond to a user's voice. A touch-sensitive surface may be provided alone or disposed over a display screen to detect and respond to a user's touch. A camera may be used for photography and for authenticating a user. Other input-sensing devices may detect motion imparted to the mobile device by sensing acceleration, rotation, compass direction, and geographical location.

A mobile device may be constrained in size in order to facilitate its transportation and convenience of use. For example, a mobile telephone may be designed to be used while held in the hand of a user. In addition to other mobile telephone components, such as processors, data storage modules, a display screen, and speakers, each of the input-sensing components previously discussed may occupy substantial physical space. Locating these input-sensing devices within the space-limited mobile device amongst the other components may prove challenging for the system architect. Additional constraints on component locations may be imposed due to power, heat-dissipation, and signal routing considerations.

### SUMMARY

Generally, a computing device as disclosed may utilize radar technology to implement virtual reality or augmented reality features, perform indoor imaging, and/or to detect gestures performed by a user. To utilize such radar technology, the computing device may include radar hardware such as transmission antennas, reception antennas, and associated circuitry. However, as discussed in further detail below, such radar hardware may interfere with operations of other components of the computing device. For instance, a radar clock signal used in operation of the radar hardware may interfere with other wireless transmitters/receivers of the computing device.

In accordance with one or more aspects of this disclosure, a signal lines for radar hardware may be shielded so as to reduce interference with other components. For instance, the signal line that carries the radar clock signal may be on a layer of a circuit board that is positioned between two ground layers of the circuit board (e.g., be sandwiched between ground layers). By placing signal lines for radar hardware on a layer of the circuit board that is between ground layers, interference from the signals carried by the signal lines may be reduced.

As one example, a computing device may include a printed circuit board comprising: a first layer including one or more ground signal paths; a second layer including one or more ground signal paths; a third layer disposed between the first layer and the second layer; a radar antenna portion comprising a first radar antenna and electrically connected to a distal connector of the printed circuit board; a radar clock signal line configured to convey a radar clock signal between the radar antenna portion and the distal connector; and a first ground guard trace electrically coupled to the one or more ground signal paths and positioned adjacent to a first side of the radar clock signal line and parallel to a length of the radar clock signal line.

The details of one or more examples of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

The accompanying drawings, which are included to provide a further understanding of the disclosed technologies, are incorporated in and constitute a part of this specification. The drawings also illustrate embodiments of the disclosed technologies and together with the detailed description serve to explain the principles of implementations of the disclosed technologies. No attempt is made to show structural details in more detail than may be necessary for a fundamental understanding of the disclosed technologies and various ways in which it may be practiced.

FIG. 1 is a block diagram of an example of a mobile computing device including a hybrid multi-layer flexible printed circuit board according to the disclosed subject matter.

FIG. 2 is an example layout of a hybrid multi-layer flexible printed circuit board according to the disclosed subject matter.

FIG. 3 is a close-up view of an example layout of a hybrid multi-layer flexible printed circuit board according to the disclosed subject matter.

FIG. 4 is a close-up view of an example layout of a hybrid multi-layer flexible printed circuit board according to the disclosed subject matter.

FIG. 5 is a close-up view of an example layout of a radar printed circuit board of a hybrid multi-layer flexible printed circuit board according to the disclosed subject matter.

FIG. 6 is a block diagram of an example of a computing device suitable for implementing certain devices.

### DETAILED DESCRIPTION

Each input function provided by a contemporary computing device may add to the total number of hardware components needed. Locating each hardware component within the limited space of a typical handheld mobile computing device may prove challenging for the system architect. In addition to the physical space requirements, locations of individual components may be constrained by power, heat-dissipation, and signal routing considerations, to name a few. Compounding the problems further, each hardware component may have specific attributes that may limit where and how it may be positioned within the mobile computing device. For example, a display screen may be limited to positions where it may be viewed by the user.

A mobile computing device as disclosed herein may incorporate millimeter wave radar technology to implement virtual reality or augmented reality features, perform indoor imaging, biomedical applications, and/or to detect proximity and gestures performed by a user. To achieve these features within the limited-space of a mobile computing device 100, a hybrid, multi-layer, flexible printed circuit board (HMLFPCB) 200 may be used. The HMLFPCB 200 may include one or more radar printed circuit boards 205 and one or more transmit (Tx) and receive (Rx) antenna(s) 501-504. In an example, the HMLFPCB 200 may include three layers. Conventional similar boards often use more than three layers. The use of fewer layers in examples disclosed herein may reduce the number of options for routing signal, power, and ground traces. For example, because the use of fewer layers may mean that the total area available for routing traces is less than in conventional devices, the power and/or ground traces may be narrowed, thereby reducing the total amount of power that may be conveyed to one or more components. Noise and crosstalk may be more prevalent where fewer layers are provided due to signals being routed in closer proximity with reduced spacing between them. Components also may be positioned more densely and may reduce the ability of the flexible printed circuit board to dissipate heat. Accordingly, features and arrangements disclosed herein may allow for the incorporation of a millimeter-scale radar technology into a portable electronic device, with little or no interference with other components of the device. Such combinations typically have not been possible in conventional devices, where incorporation of the radar chip or equivalent technology would have a detrimental effect on the operation or inclusion of other components in the device.

The terms, “path,” “trace,” and “line” as used herein refer to any electrical coupling configured to transmit power and/or signals as described herein and according to the commonly-understood meaning of each term in the art. For example, a signal path or signal line may be implemented using one or more electrical wires, one or more traces on a printed circuit board, one or more electrically conductive pins, and the like. Each type of electrical coupling may be substituted for another, depending on the desired implementation, without departing from the scope of the present subject matter.

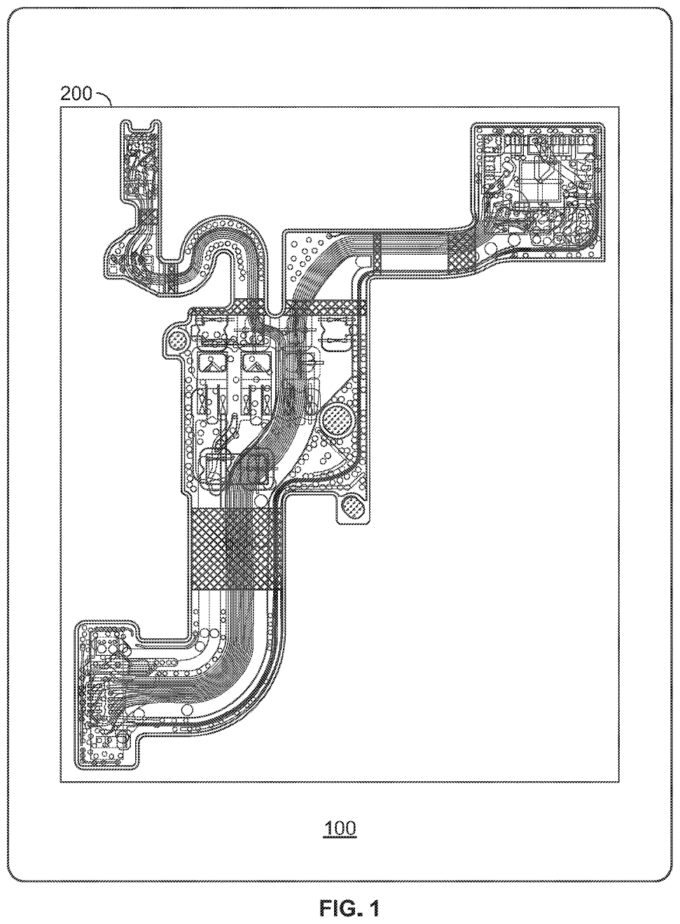

FIG. 1 illustrates a mobile computing device 100 according an example of the disclosed subject matter. Mobile computing device 100 may be, for example, a smart phone, tablet, notebook or laptop computer, e-reader, portable digital assistant, handheld gaming device, or the like. The mobile computing device 100 may include a radar printed circuit board, such as HMLFPCB 200, as will be subsequently discussed. In accordance with one or more aspects of this disclosure, the radar printed circuit board may include at least two ground layers and one or more radar signals lines may be positioned on a layer located between the ground layers. While illustrated and described as a mobile computing device, this disclosure may be equally applicable to non-mobile devices that include radar hardware.

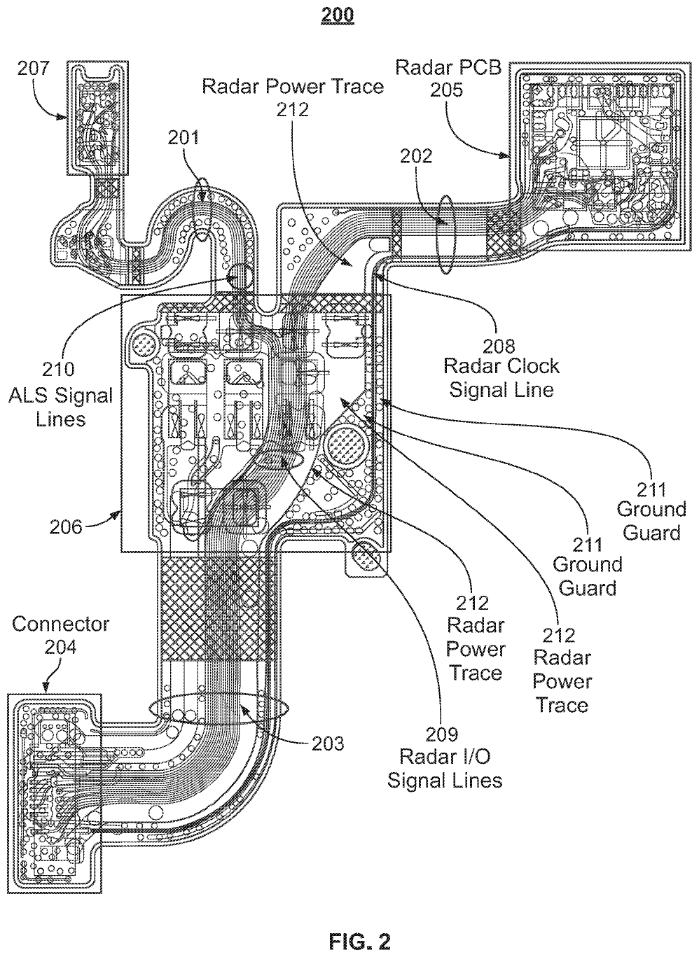

FIG. 2 shows an example of a layout of a HMLFPCB 200. The HMLFPCB 200 may include or more flexible portions 201, 202, 203, one or more inflexible portions 204, 206, 207, and a radar printed circuit board (PCB) 205. Flexible portions 201, 202, 203 may be flexible in that they may bend and/or twist without severing. Inflexible portions 204, 206, 207 may be incapable of bending and/or twisting to the same degree as flexible portions 201, 202, 203 without severing. In an example, the HMLFPCB 200 may include multiple layers, for example between two and six layers. Radar PCB 205 may include one or more radar integrated circuits and one or more transmit and/or receive antennas 501-504. Portion 206 may include one or more traces including radar input/output (I/O) signal lines 209 and radar clock signal line routed from connector 204 to radar PCB 205. Portion 206 may also include one or more traces 210 including ALS signals lines 210 routed between connector 204 and portion 207. Portions 202, 203, 204, 206, and radar PCB 205 may include one or more ground guard traces 211 adjacent to radar clock signal line 208. A radar power trace 212 having one or more traces may route radar power between connector 204 and radar PCB 205.

It should be appreciated that any of the described signal lines, traces, connectors, antennas, or other components may be positioned on any layer of the multiple layers of the HMLFPCB 200 without departing from the scope of the present subject matter. In an example, HMLFPCB 200 may include three layers, where signals may be routed on the second layer that is disposed between a first and third layer upon which only ground traces may be positioned. In an example, only high-frequency signals may be routed on the second layer while signals that are low-frequency may be routed on one or more of the outer layers. Routing signals in the middle second layer rather than the outermost layers may prevent digital noise from coupling into the radar I/O signal lines 209. Vertical interconnect access (via) stitching may be incorporated along the edge of the HMLFPCB 200 to connect the ground paths of the first and third layers or the otherwise outermost layers together. The via stitching in conjunction with the ground traces positioned on the first and third layers or the otherwise outermost layers may together create a Faraday cage. The Faraday cage may prevent or reduce the amount of electromagnetic interference (EMI) escaping from the edges of the HMLFPCB 200 and causing noise in other signals and components of the mobile computing device 100.

One or more ground guard traces 211 may also be incorporated adjacent to the radar clock signal line 208 and parallel to the length of clock signal line 208 to insulate nearby signal lines, such as radar I/O signal lines 209, from radiating noise generated by the switching of the radar clock signal line 208. Ground guard traces 211 may also insulate the radar clock signal line 208 from incoming EMI generated by other sources, such as components, signals, and sources of power. Ground guard traces 211 and/or other ground traces used throughout the HMLFPCB 200 may be implemented using a minimum trace width between 0.05 mm and 0.25 mm. In some examples, the minimum trace width may be 0.12-0.18 mm, 0.13-0.17 mm, 0.14-0.16 mm, or approximately 0.15 mm. In an example, there may be a corresponding ground trace positioned vertically in-line on a layer above the radar clock signal line 208, a layer below the radar clock signal line 208, or both within the HMLFPCB 200. The ground trace layer(s) above and/or below a layer containing signal lines may be located immediately adjacent or separated by one or more other layers of the HMLFPCB 200. An EMI film may also be applied to HMLFPCB 200 to reduce the amount of EMI emitted.

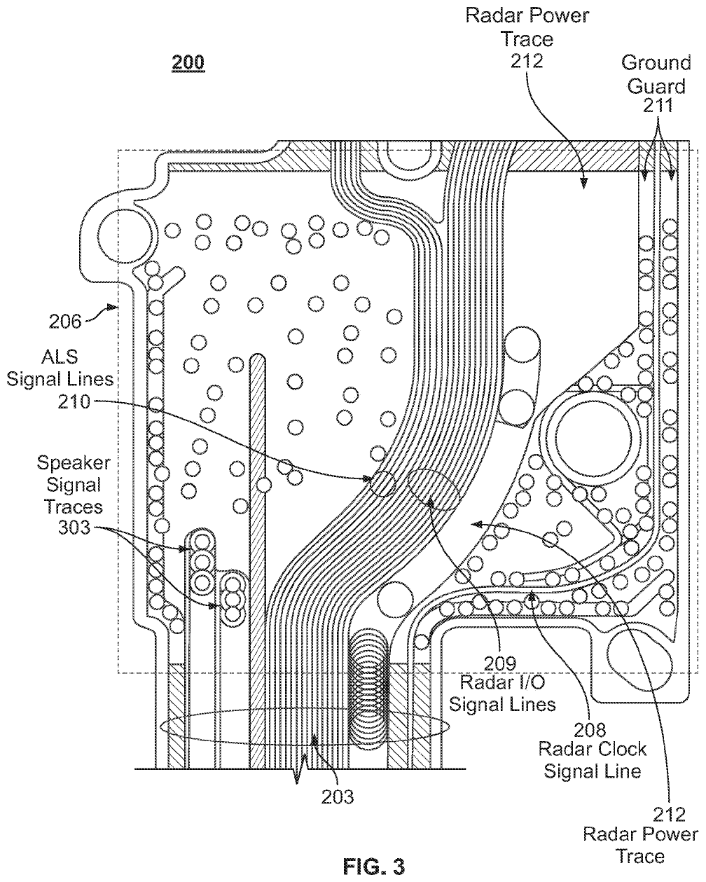

FIG. 3 shows a close-up view of HMLFPCB 200 according to an example of the disclosed subject matter. As shown in FIG. 3, the radar clock signal line 208 may be flanked on either or both sides by adjacent ground guard traces 211. FIG. 3 also shows radar I/O signal lines 209, which may be transmitted adjacently to ALS signal lines 210 substantially across portion 206. As shown, radar power trace 212 may transmit radar power using a trace substantially wider than traces utilized for radar I/O signal lines 209 and ALS signal lines 210 in order to minimize direct current (DC) resistance and the associated voltage drop. Radar power trace 212 may reach its widest point on portion 206. One or more speaker signal traces 303 that connect to one or more speakers of mobile computing device 100 may also be transmitted between connector 204 and portion 206 through portion 203 as shown in FIG. 3. In an example, speaker signal traces 303 may be isolated from other signals paths 209, 210 and power trace 212 by appropriate distances and/or ground buses. In an example, sensitive signals such as speaker signal traces 303 may be spaced from other signals by a minimum distance between 0.1 mm and 0.5 mm both horizontally on the same layer and vertically between layers of the HMLFPCB 200. Some examples may use a minimum distance of 0.2-0.4 mm or about 0.3 mm. In this way, current spikes and other forms of EMI may be reduced or prevented from being introduced into speaker signal traces 303.

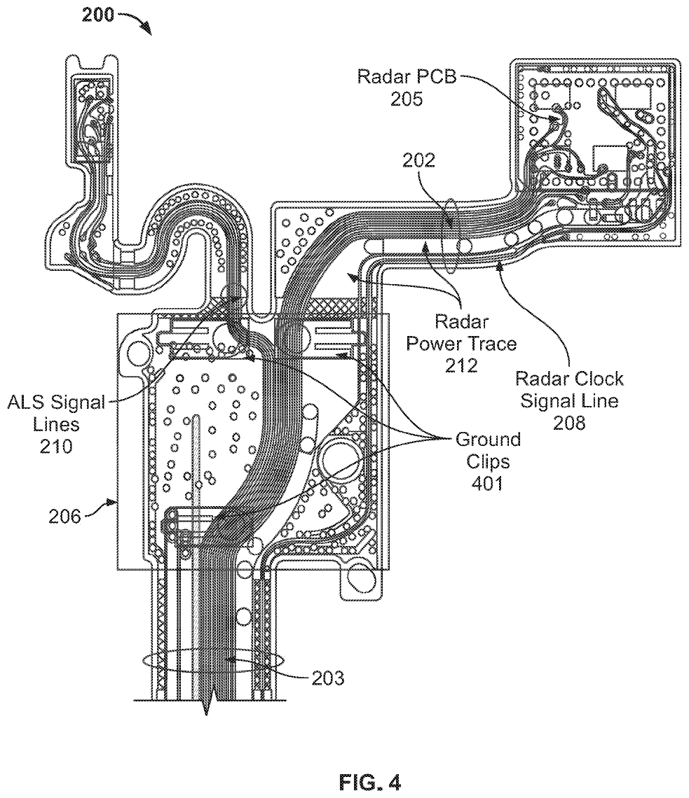

FIG. 4 shows a close-up view of HMLFPCB 200 according to an example of the disclosed subject matter. As shown in FIG. 4, ground clips 401 may be provided on the HMLFPCB 200. Power for radar components may be conveyed by radar power trace 212 between radar PCB 205 and connector 204 through portions 202, 203, and 206 as shown.

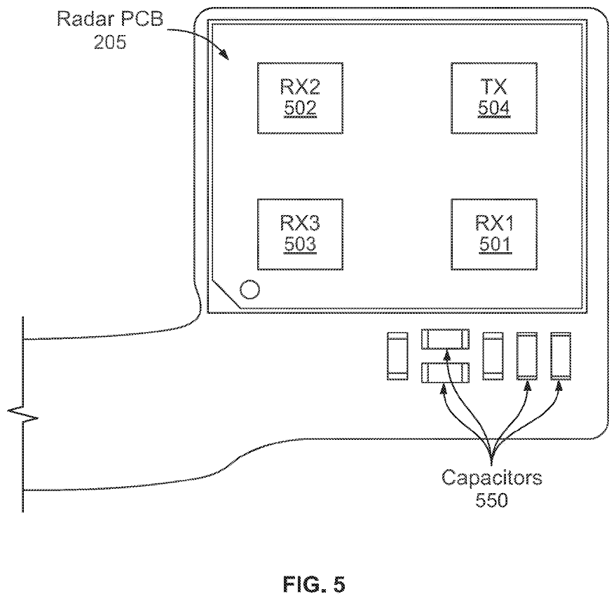

FIG. 5 shows a close-up view of radar PCB 205 according an example of the disclosed subject matter. Radar PCB 205 may include one or more radar antennas 501-504 configured to transmit and/or receive radar waves. In an example, radar PCB 205 may include a transmission (TX) radar antenna 504 and three reception radar antennas 501-503. Radar PCB 205 may also include one or more capacitors 550 electrically coupled to radar power trace 212 to support increased and more efficient power delivery to components of radar PCB 205. Radar antennas 501-504 may be grounded at multiple points of the HMLFPCB 200. In an example, six different grounding points may be employed to provide a path to ground for the radar antennas 501-504. Three antenna grounding points may be located on the backside of the HMLFPCB 200 and connected with a housing of the mobile computing device 100. One grounding point may be located adjacent to an ambient light sensor, one grounding point may be located adjacent to an Oslo sensor, and one grounding point may be located on a reverse side of the Oslo sensor on a separate printed circuit board.

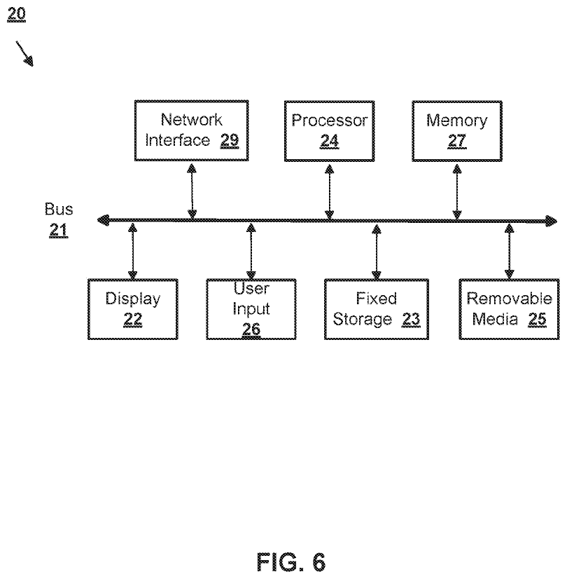

FIG. 6 is a block diagram of an example of a computing device 20 suitable for implementing certain devices. The computing device 20 can be used to implement, for example, the mobile computing device 100 as described above.

The computing device 20 can include a bus 21 that interconnects major components of the computing device 20. Such components can include a central processor 24; a memory 27 (such as Random Access Memory (RAM), Read-Only Memory (ROM), flash RAM, or the like), a sensor 28 (which can include one or more sensors), a display 22 (such as a display screen), an input interface 26 (which can include one or more input devices such as a keyboard, mouse, keypad, touch pad, turn-wheel, and the like), a fixed storage 23 (such as a hard drive, flash storage, and the like), a removable media component 25 (operable to control and receive a solid-state memory device, an optical disk, a flash drive, and the like), a network interface 29 (operable to communicate with one or more remote devices via a suitable network connection), and a speaker 30 (to output an audible communication). In some examples, the input interface 26 and the display 22 can be combined, such as in the form of a touchscreen.

The bus 21 can allow data communication between the central processor 24 and one or more memory components 23, 27, which can include RAM, ROM, or other memory. Applications resident with the computing device 20 generally can be stored on and accessed via a computer readable storage medium.

The fixed storage 23 can be integral with the computing device 20 or can be separate and accessed through other interfaces. The network interface 29 can provide a direct connection to the premises management system and/or a remote server via a wired or wireless connection. The network interface 29 can provide such connection using any suitable technique and protocol. For instance, network interface 29 may include one or more wireless transceivers to facilitate communication via one or more techniques/protocols including digital cellular telephone, WiFi™, Thread®, Bluetooth®, near field communications (NFC), and the like. As such, the network interface 29 can allow the computing device 20 to communicate with other components of the premises management system or other computers via one or more local, wide-area, or other communication networks.

The following numbered example may illustrate one or more aspects of the disclosure:

Example 1. A computing device comprising: a printed circuit board comprising: a first layer including one or more ground signal paths; a second layer including one or more ground signal paths; a third layer disposed between the first layer and the second layer; a radar antenna portion comprising a radar antenna and electrically connected to a distal connector of the printed circuit board; a radar clock signal line configured to convey a radar clock signal between the radar antenna portion and the distal connector; and a first ground guard trace electrically coupled to the one or more ground signal paths and positioned adjacent to a first side of the radar clock signal line and parallel to a length of the radar clock signal line.

Example 2. The computing device of example 1, wherein the first layer is electrically connected to the third layer.

Example 3. The computing device of example 1, wherein the first layer is electrically connected to the third layer by a plurality of vertical interconnect access stitches along an edge of the printed circuit board.

Example 4. The computing device of example 1, wherein the radar antenna portion, the radar clock signal line, and the first ground guard trace are positioned on the third layer.

Example 5. The computing device of example 1, wherein the computing device is a mobile computing device that includes one or more wireless transceivers.

Example 6. The computing device of example 1, wherein the radar antenna portion further comprises one or more additional radar antennas.

Example 7. The computing device of example 6, wherein the radar antenna is a transmitting antenna and the one or more additional radar antennas are receiving antennas.

Example 8. The computing device of example 7, wherein the one or more additional radar antennas comprise at least three receiving antennas.

Example 9. The computing device of example 1, further comprising a second ground guard trace positioned adjacent to a second side of the radar clock signal line and parallel to the length of the radar clock signal line.

Example 10. The computing device of example 1, wherein the radar clock signal line is configured to convey the radar clock signal between the radar antenna portion and the distal connector.

Example 11. The computing device of example 1, wherein the first ground guard trace has a minimum width not less than 0.05 mm and not more than 0.25 mm.

Example 12. The computing device of example 1, further comprising a first corresponding ground signal path positioned vertically in-line with the radar clock signal line on one of the first layer and the second layer.

Example 13. The computing device of example 1, further comprising: a radar power trace configured to convey power between the radar antenna portion and the distal connector; and a plurality of radar input/output signal lines.

Example 14. The computing device of example 13, wherein the radar power trace is separated from the radar clock signal line and from the plurality of radar input/output signal lines by a minimum distance of about 0.3 mm.

Example 15. The computing device of example 13, wherein a width of the radar power trace is greater than a width of a signal line of the plurality of radar input/output signal lines.

Example 16. The computing device of example 1, further comprising a plurality of ground clips.

Example 17. The computing device of example 1, wherein the radar antenna is connected to ground via a plurality of ground points.

Example 18. The computing device of example 17, further comprising an ambient light sensor, wherein at least one ground point of the plurality of ground points is located adjacent to the ambient light sensor.

Example 19. The computing device of example 17, wherein the printed circuit board comprises a hybrid, multi-layer, flexible printed circuit board.

Example 20. The computing device of example 19, further comprising one or more speakers, wherein the printed circuit board further comprises a plurality of speaker signal traces connected to the one or more speakers, and wherein the plurality of speaker signal traces are isolated from radar input/output signal lines.

The foregoing description, for purpose of explanation, has been described with reference to specific configurations. However, the illustrative discussions above are not intended to be exhaustive or to limit configurations of the disclosed technologies to the precise forms disclosed. Many modifications and variations are possible in view of the above teachings. The configurations were chosen and described in order to explain the principles of the disclosed technologies and their practical applications, to thereby enable others skilled in the art to utilize those configurations as well as various configurations with various modifications as may be suited to the particular use contemplated.

1. A computing device comprising:
a printed circuit board comprising:
a first layer including one or more ground signal paths;
a second layer including one or more ground signal paths;
a third layer disposed between the first layer and the second layer;
a radar antenna portion comprising a radar antenna and electrically connected to a distal connector of the printed circuit board;
a radar clock signal line configured to convey a radar clock signal between the radar antenna portion and the distal connector; and
a first ground guard trace electrically coupled to the one or more ground signal paths and positioned adjacent to a first side of the radar clock signal line and parallel to a length of the radar clock signal line.

2. The computing device of claim 1, wherein the first layer is electrically connected to the third layer.

3. The computing device of claim 1, wherein the first layer is electrically connected to the third layer by a plurality of vertical interconnect access stitches along an edge of the printed circuit board.

4. The computing device of claim 1, wherein the radar antenna portion, the radar clock signal line, and the first ground guard trace are positioned on the third layer.

5. The computing device of claim 1, wherein the computing device is a mobile computing device that includes one or more wireless transceivers.

6. The computing device of claim 1, wherein the radar antenna portion further comprises one or more additional radar antennas.

7. The computing device of claim 6, wherein the radar antenna is a transmitting antenna and the one or more additional radar antennas are receiving antennas.

8. The computing device of claim 7, wherein the one or more additional radar antennas comprise at least three receiving antennas.

9. The computing device of claim 1, further comprising a second ground guard trace positioned adjacent to a second side of the radar clock signal line and parallel to the length of the radar clock signal line.

10. The computing device of claim 1, wherein the radar clock signal line is configured to convey the radar clock signal between the radar antenna portion and the distal connector.

11. The computing device of claim 1, wherein the first ground guard trace has a minimum width not less than 0.05 mm and not more than 0.25 mm.

12. The computing device of claim 1, further comprising a first corresponding ground signal path positioned vertically in-line with the radar clock signal line on one of the first layer and the second layer.

13. The computing device of claim 1, further comprising:
a radar power trace configured to convey power between the radar antenna portion and the distal connector; and
a plurality of radar input/output signal lines.

14. The computing device of claim 13, wherein the radar power trace is separated from the radar clock signal line and from the plurality of radar input/output signal lines by a minimum distance of about 0.3 mm.

15. The computing device of claim 13, wherein a width of the radar power trace is greater than a width of a signal line of the plurality of radar input/output signal lines.

16. The computing device of claim 1, further comprising a plurality of ground clips.

17. The computing device of claim 1, wherein the radar antenna is connected to ground via a plurality of ground points.

18. The computing device of claim 17, further comprising an ambient light sensor, wherein at least one ground point of the plurality of ground points is located adjacent to the ambient light sensor.

19. The computing device of claim 17, wherein the printed circuit board comprises a hybrid, multi-layer, flexible printed circuit board.

20. The computing device of claim 19, further comprising one or more speakers, wherein the printed circuit board further comprises a plurality of speaker signal traces connected to the one or more speakers, and wherein the plurality of speaker signal traces are isolated from radar input/output signal lines.
